(19) United States
(12) Patent Application Publication
(10) Pub. No.: US 2006/0252328 A1
(43) Pub. Date: Nov. 9, 2006

(54) Fiber reinforced resin/construction and method for providing blast absorption and deflection characteristics and associated fastening system utilized with such a contruction

(76) Inventor: Mel Bingenheimer, Norman, OK (US)

Correspondence Address: GIFFORD, KRASS, GROH, SPRINKLE & CITKOWSKI, P.C, PO BOX 7021, TROY, MI, 48007-7021, US

(21) Appl. No.: 11/141,435

(22) Filed: May 31, 2005

Related U.S. Application Data
(63) Continuation-in-part of application No. 10/756,727, filed on Jan. 13, 2004, now Pat. No. 6,998,359.
(60) Provisional application No. 60/575,581, filed on May 28, 2004.

(51) Int. Cl. B32B 17/02

(52) U.S. Cl. 442/180; 156/39

(57) ABSTRACT

A multiple layer fiber reinforced material and method of constructing the same including the provision of a first layer of a roll lofted glass material over a deformation retardant wire mesh. A second layer of a fiber reinforced material is applied over the glass material and is followed by at least a further layer of glass material. A resin is intermixed with the layers of glass material and fiber reinforced material, the resin exhibiting elongation properties substantially consistent with those associated with the layer of fiber reinforced material and in order to produce a blast force resistant article. An outer ceramic based and sacrificial layer provides additional force absorption and dissipation.

### CROSS REFERENCE TO RELATED APPLICATIONS

The present application claims the priority of U.S. Provisional Patent Application Ser. No. 60/575,581, filed May 28, 2004, and is a continuation-in-part of U.S. patent application Ser. No. 10/756,727 filed Jan. 13, 2004.

### BACKGROUND OF THE INVENTION

1. Field of the Invention

The present invention discloses a solid three-dimensional article constructed of alternating, typically individually plural, layers of a lofted glass material alternated with a carbon Kevlar fiber. The multiple layers are held together by a volume of a flowable resin and which, upon being cured within a mold, exhibit consistent and enhanced elongation properties for providing increased blast force absorption and deflection. The present invention also discloses a process for creating a three-dimensional construction according to the above description, as well as a two-piece assembleable fastener for securing together configured sheets or other assembleable components constructed according to the above.

2. Description of the Prior Art

The prior art is well documented with various examples of ballistic or impact/penetration-resistant fabrics and solids, and such as which are usually incorporated into structural or acoustic support structures. The purpose of such materials is in providing a synthetic composition which is capable of being applied to any of a number of different structural applications.

Among the examples disclosed by the prior art is U.S. Pat. No. 5,545,455, issued to Prevorsek et al., which discloses an improved rigid composite including a plurality of fibrous layers, at least two of which are secured together by a securing means, and which further includes at least two adjacent paths. The articles produced thereby are fiber based and are suitable for fabrication into rigid penetration resistant articles such as vehicle panels, spall liners for military vehicles and the like.

U.S. Pat. No. 5,190,802, issued to Pilato, teaches improved ballistic-resistant laminates developed by bonding alternating plies of fabric woven from glass or normally solid organic polymers and non-woven scrim prepreg impregnated with a heat curable resin. A preferred organic polymer is an aramid exemplified by Kevlar. A preferred heat curable resin is phenol-formaldehyde/polyvinyl butyral blend.

U.S. Pat. No. 6,562,435, issued to Brillhart, III et al., teaches a method for forming a sheet of unidirectionally-oriented fiber strands which includes unidirectional fibers, bonding fibers interwoven with the unidirectional fibers to form a fiber panel, and thermoplastic film laminating the fiber panel therebetween. In one embodiment, a second sheet of laminated unidirectional fibers is joined to the first sheet, and such as with the fibers running in a second direction as compared to the first fibers. In yet another embodiment, individual laminated sheets of unidirectional fibers are stitched together to form packets of sheets which may be used singularly or multiple packets which may be bundled together.

U.S. Provisional Application Serial No. 2001/0053645 teaches a multi-layered ballistic-resistant article including at least one layer of hard armor and at least one layer of fibrous armor composite. Each fibrous armor composite layer includes two or more layers of a fibrous ply, each fibrous ply having a plurality of unidirectional oriented fibers. Upon the layers of plies being aligned to form the composite, the fibers in adjacent fibrous plies are arranged at an acute angle to each other.

### SUMMARY OF THE PRESENT INVENTION

The present invention discloses a solid three-dimensional article constructed of alternating, typically individually plural, layers of a lofted glass material alternated with a carbon Kevlar fiber layer. In various preferred embodiments, each succeeding layer of material is provided with a given number of sub-plies of material.

The multiple layers are held together by a volume of a flowable resin and which, upon being cured within a mold, exhibit consistent and enhanced elongation properties for providing increased blast force absorption and deflection. In a preferred application, a chemical recipe associated with the resin mixture exhibits elongation properties consistent with those of at least the fiber reinforced layers and such that enhanced properties, up to twenty-five percent corresponding to an overall volume of the material, are possible.

Additional features include the provision of a ceramic based outer layer, for blast-resistant protection, and in addition to the provision of an innermost mesh screen constructed from such as wire, steel or titanium based materials, such further preventing inward bowing/deflection of the sandwiched layers resulting from impact forces. It is also envisioned that appropriately configured and ceramic covered plates of material can be constructed, such as which may further be interlocked together, in order to provide a blast resistant surface.

The present invention also discloses a method for creating a multiple layer reinforced material according to the above description, as well as a two-piece assembleable fastener for securing together configured sheets or other assembleable components constructed according to the above.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an exploded view of the multiple layer fiber reinforced material according to a preferred embodiment of the present invention;

FIG. 2 is an assembled view of the reinforced material according to the first preferred embodiment;

FIG. 3 is an enlarged sectional view of the reinforced material shown in FIG. 2 and which better illustrates the alternating nature of the lofted glass and fiber reinforced layers of material;

FIG. 4 is a flow schematic of a process for creating a multiple layer fiber reinforced material according to the present invention;

FIG. 5 is a perspective illustration of a non-planar three-dimensional article produced according to the present invention;

FIG. 6 illustrates in sectional perspective, an overlapping lap joint edge established between first and second sheets of material produced according to the present invention;

FIG. 7 illustrates an exploded view of a two-piece and frusto-conical shaped fastener assembled in opposing fashion within aligning and likewise frusto-conical shaped apertures defined within the overlapping lap joint edge;

FIG. 8 is an illustration of one half of a mold for producing a two-piece fastener from an admixture of chopped glass fiber strands and resin;

FIG. 9 is a perspective illustration of appropriately configured and ceramic covered plates of material arranged in a desired fashion to provide a blast resistant surface; and

FIG. 10 is a further perspective illustration of a plurality of ceramic covered and multiple layer fiber reinforced materials, such as which may further be configured so as to be interlocked together, and in order to provide a blast resistant surface.

### DETAILED DESCRIPTION OF THE PREFERRED EMBODIMENTS

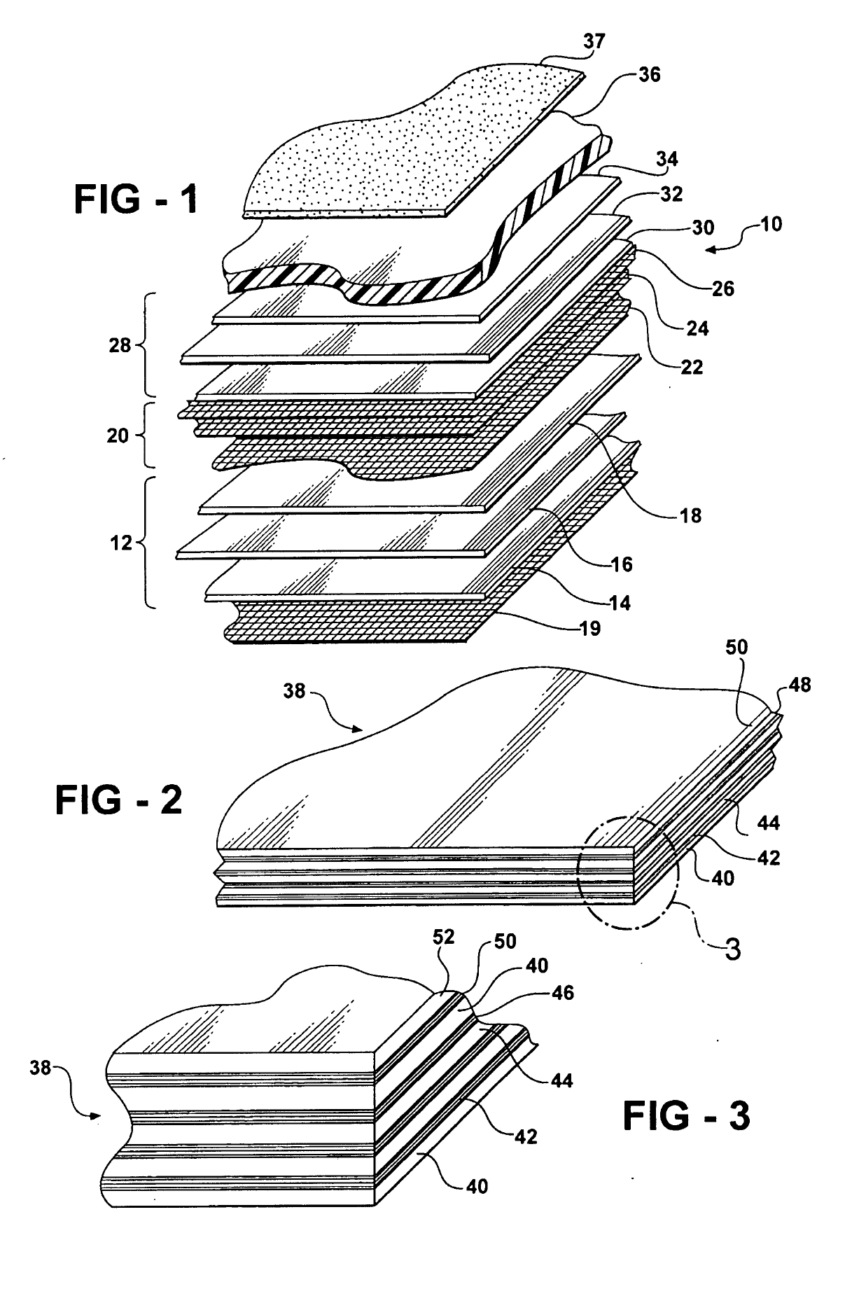

Referring now to FIG. 1, an exploded illustration is shown at 10 of a multiple layer fiber reinforced material according to a preferred embodiment of the present invention. The present invention is particularly suited for producing a blast-resistant material for incorporation into such as a floor of a vehicle as well as in a myriad of other applications as will be subsequently described.

The material includes a first layer, referenced generally at 12, of a lofted glass material. In a preferred application, the lofted glass layer 12 is actually represented by individual sub-layers, see at 14, 16 and 18, of material which are stacked one upon the other.

A substratum layer of a wire mesh material 19, such as including without limitation, steel, titanium or other suitable mesh material, may be laid into a mold and upon which the first layers of lofted glass 14-18, are subsequently applied. The wire mesh material 19 can be interchangeably used through the three dimensional articles disclosed in the present invention, it further being generally understood that the wire mesh 19 is, in a preferred variant, located proximate an innermost location of the article in order to prevent excessive inward bowing or deflection of the finished article and in response to forces associated with a blast or detonation.

A second layer of a fiber reinforced material is illustrated generally at 20 and includes individual plies 22, 24, and 26 of material, typically with each ply arranged in an alternating crosswise extending fashion. Three such plies are shown, however it is understood that any plurality of plies, such as seventeen plies, can be provided in a given overall layer 20, the same being true as to the number of lofted glass sub-layers 14, 16 and 18.

A third layer of a lofted glass material is further represented generally at 28 and includes additional sub-layers represented at 30, 32 and 34. As with the first sub-layers 14, 16 and 18 of lofted glass, any number of individual sub-layers of lofted glass can be incorporated according to the invention.

A volume of a flowable resin is intermixed with the layers of glass and fiber reinforced material. In the exploded illustration of FIG. 1, the resin volume is referenced at 36 as a single volume applied over the sandwiched layers 12, 20 and 28. As will be further discussed, it is also envisioned that individual sub-volumes of resin can be applied between each succeeding layering of lofted glass and fiber reinforced material.

A layer or sheet of a ceramic based material 37 is illustrated in FIG. 1 and which is typically placed upon the resin material 36. The ceramic material 37, in a preferred embodiment, defines an outermost blast-absorbing layer associated with the completed article and can be provided as a single or multiple overlaying sheets. It is further understood that, with reference to the several embodiments disclosed throughout, the ceramic layer(s) 37 can be provided at any location (interior or exterior) relative to the preceding disclosed glass loft or fiber mesh materials.

The ceramic layer 37 typically constitutes an outermost or sacrificial layer and which, as a result of absorbing a significant percentage of force and shrapnel associated with an explosive impact, shatters in the dissipation of such forces and to further add to the effectiveness of the article. In varying applications, the thickness of the ceramic layer can vary from ⅜″, upwards to 6-12 inches.

Referring to the assembled and enlarged sectional views of FIGS. 2 and 3, both referenced generally at 38 any number of alternating layers of glass and reinforced fibers can be incorporated into the reinforced material, either with or without the additional application of the inner steel/titanium mesh or outer ceramic sacrificial layers illustrated in FIG. 1. In the example illustrated, lofted glass layers 40, 44, 48 and 52 are alternated with fiber reinforced layers 42, 46 and 50. As previously explained, any plurality of alternating layers can be implemented according to the present invention.

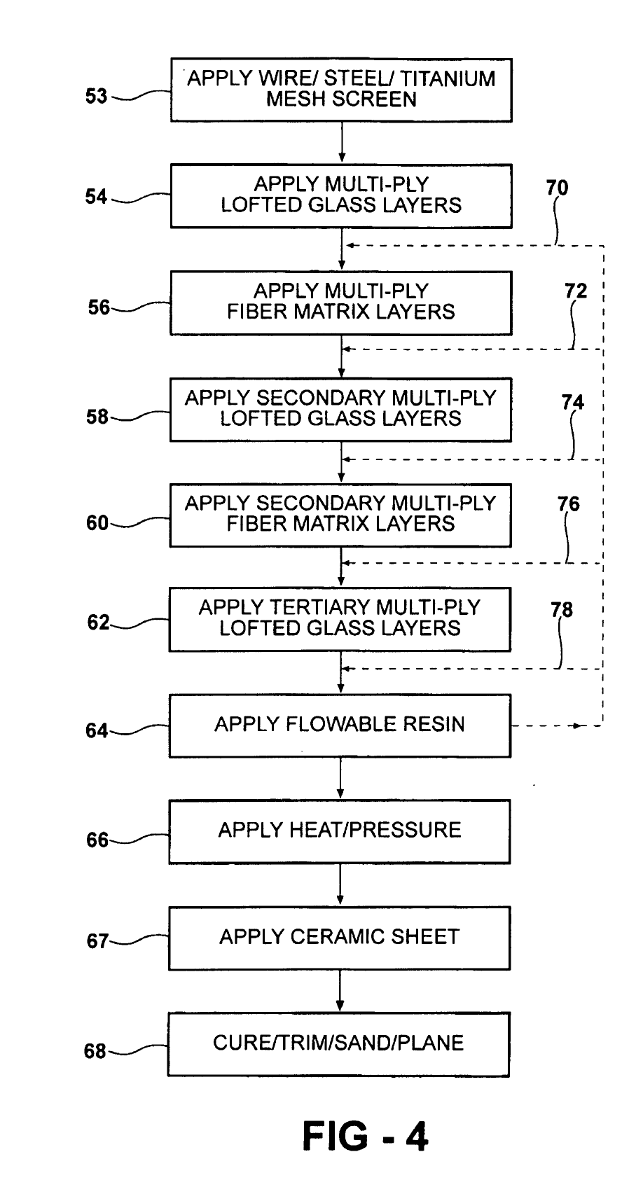

In application, and referring to the application steps set forth in FIG. 4, the initial application of the underlaying wire/steel/titanium mesh 53 is followed by application of the multi-ply lofted glass layers illustrated at 54, followed by the sequential applications of multi-ply fiber matrix layers 56 and secondary multi-ply lofted glass layers 58. Additional steps include the secondary multi-ply fiber matrix layers 60, and tertiary multi-ply lofted glass layers.

At step 64, a volume of the flowable resin is applied. In one variant, the resin is applied in a single application within a compressible mold within which the layers of material are deposited. Upon the application of heat and pressure (step 66), the layers of material, such as referenced in FIG. 1, are compressed (in one example from 6″ to ½″ to ¾″) into a reinforced solid, such as again referenced in FIG. 2. At this point, a ceramic based sheet of desired thickness may be applied at 67 and subsequent finishing steps including curing/trimming/sanding and planing (see step 68) the reinforced article, as well as the application of a surface coating of a water-impervious material (such as a sprayable latex or acrylic) applied to at least one surface associated with the material.

A feature of the invention is the ability of the reinforced material to exhibit increased elongation properties, these being determined critical to assist in absorbing such as in particular blast forces associated with such as bombs, heavy objects and the like. One desired application in particular is the placement of the reinforced material, as forming a part of an armored vehicle wall or flooring. Additional applications include applying the reinforced articles as plating for ship hulls, tanks, Humvee armor, and the like.

Tests conducted with multi-layered articles as disclosed herein yield impressive ratings for such as compressive modulus, flexural modulus, tensile modulus and elongation at point of rupture. In sheet form, overall weight per thickness can vary, in certain instances it having been found that ⅝″ thickness profile yields a weight of 6.0 lbs/sq. ft., a ¾″ profile 7.2. lbs/sq. ft. and a 1″ profile 9.6 lbs/sq. ft.

Compressing of the layers within the mold causes the flowable resin 64 to intermix (and to substantially flow through) with each of the succeeding lofted glass and fiber reinforced layers. As further referenced by dashed lines 70, 72, 74, 76 and 78, intermediate applications of flowable resin may be applied between each succeeding and alternating application of lofted glass layers and fiber matrix layers.

The resin is typically applied in a range of fifteen to eighty-five percent by weight in comparison to the aggregated weight of the layers of glass and fiber reinforced materials. The resin may further be constructed of any of a polyurethane, epoxy, polyester, bi-phenol polyester, phenol formaldehyde, isothallic polyester, orthothallic polyester and a vinyl ester.

The elongation properties associated with the reinforced article include typically 12% for the Kevlar strands and 8% for the carbon strands associated with the fiber reinforced plies of material. The lofted glass layers may further typically possess an elongation rate in the range of 6% by volume.

In a preferred application, it is desired that the embedding resin exhibit the same elongation percentage as at least the fibers. In order to accomplish this, the chemical recipe associated with the overall resin layer 64 and/or the individual resin layers 70, 72, 74, 76 and 78, may be individually modified to associate different elongation properties with different layer compositions.

A desired overall elongation range associated with the three-dimensional article is in an overall range of six to twenty-five percent corresponding to an overall volume of the material. For purposes of the present invention, 16% elongation is one desired objective. This corresponds to the finished material exhibiting a density in a range of 55-72 lbs/ft3, an impact load resistance ranging from 6700 psi to 8000 psi, as well as a tensile strength rating of between 155-225 kips per square inch.

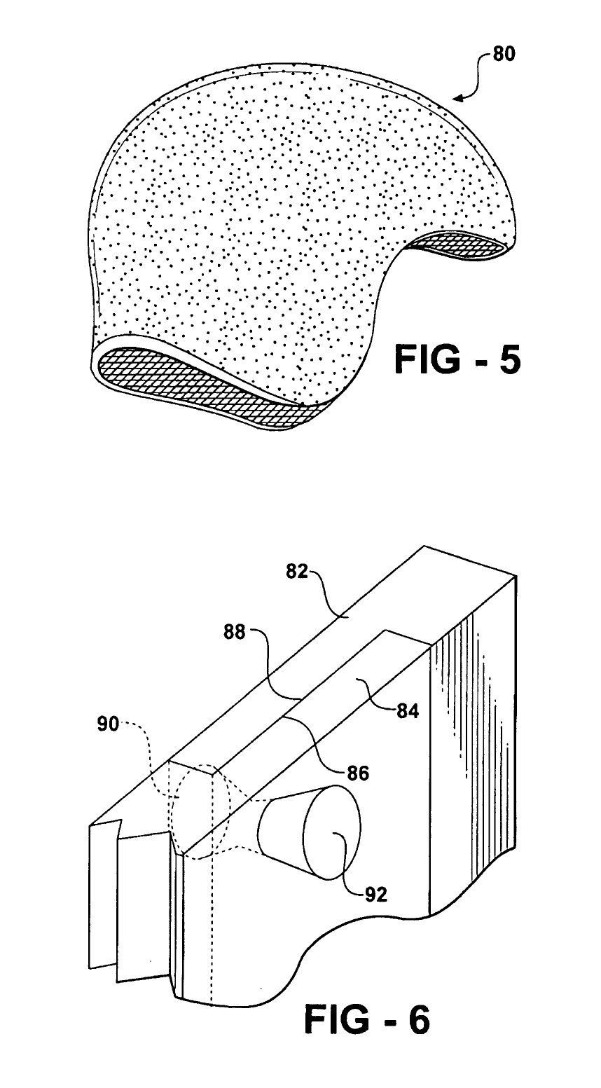

Referring further to FIG. 5, an illustration is generally represented at 80 of a non-substantially planar shaped article, such as a helmet, produced according to the present invention. As illustrated, the article 80 is produced in a fashion consistent with the disclosure of FIGS. 1-4, and may include either or both a ceramic based (sacrificial) outermost layer in cooperation with a deformation-retardant inner steel/titanium mesh layer. As previously discussed, other possible shaped articles can be produced according to the invention and which include configured components for vehicle wheel well assemblies, rigid inserts for such as battle gear, and the like, it being also understood that the ceramic layer(s) are capable of being preconfigured in any of a variety of different shapes.

Referring now to FIGS. 6-8, a fastener scheme is disclosed for securing together such as two individual sheets 82 and 84 of reinforced material. A problem associated with the prior art is the use of metal bolts in fastening together individual pieces of material and which, upon the occurrence of an explosion, causes the bolts to fragment into shrapnel.

A solution for this problem is the production of a two-piece fastener constructed from reinforced glass/fiber strands and which exhibit elongation properties matching that of the associated pourable resin. The first and second sheets of material 82 and 84 each include a narrowed portion exhibiting an extending and overlapping edge, see at 86 and 88, respectively, associated with a lap joint.

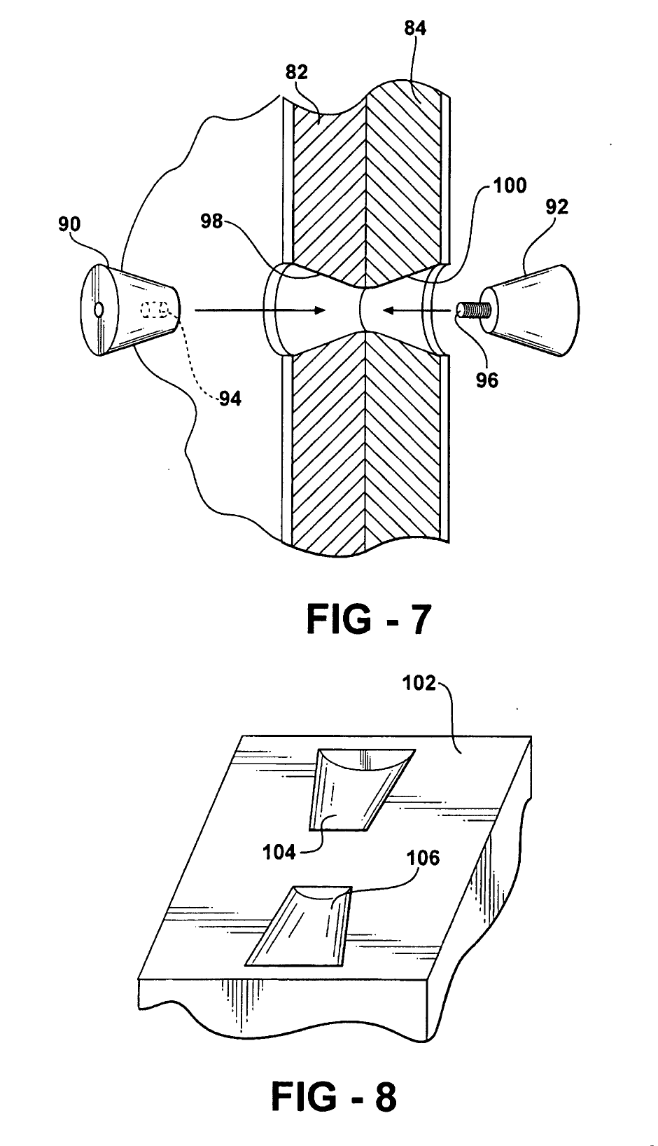

Fasteners are provided in the form of a two-piece and assembleable pin, see at 90 and 92 in FIG. 7. The fasteners each exhibit a frusto-conical shape, the first fastener 90 further exhibiting an interiorly recessed inner end 94 which mates with an associated and exteriorly threaded portion 96 extending from an opposing end of the second pin 92. Aligning recesses are formed in the overlapping and extending edges of the sheets, see at 98 and 100, for receiving, in inserting fashion, the pin pieces 90 and 92, the same being subsequently rotated relative to one another and so as to be engageably locked in place.

As best shown in FIG. 8, a first half of a mold 102 includes a recessed configuration corresponding to one half of a three-dimensional shape achieved by the finished fastener. The material content of the fastener pieces includes reinforced chopped glass/fiber strands into which are chemically engineered elongation properties consistent with a matching resin binder. In use, the assembled fastener components 90 and 92 (see in FIG. 6) secures together the sheets 82 and 84 in such a fashion that, in the instance of a collision, fragmentation of the fastener will be consistent with an overall similar material content associated with the reinforced material.

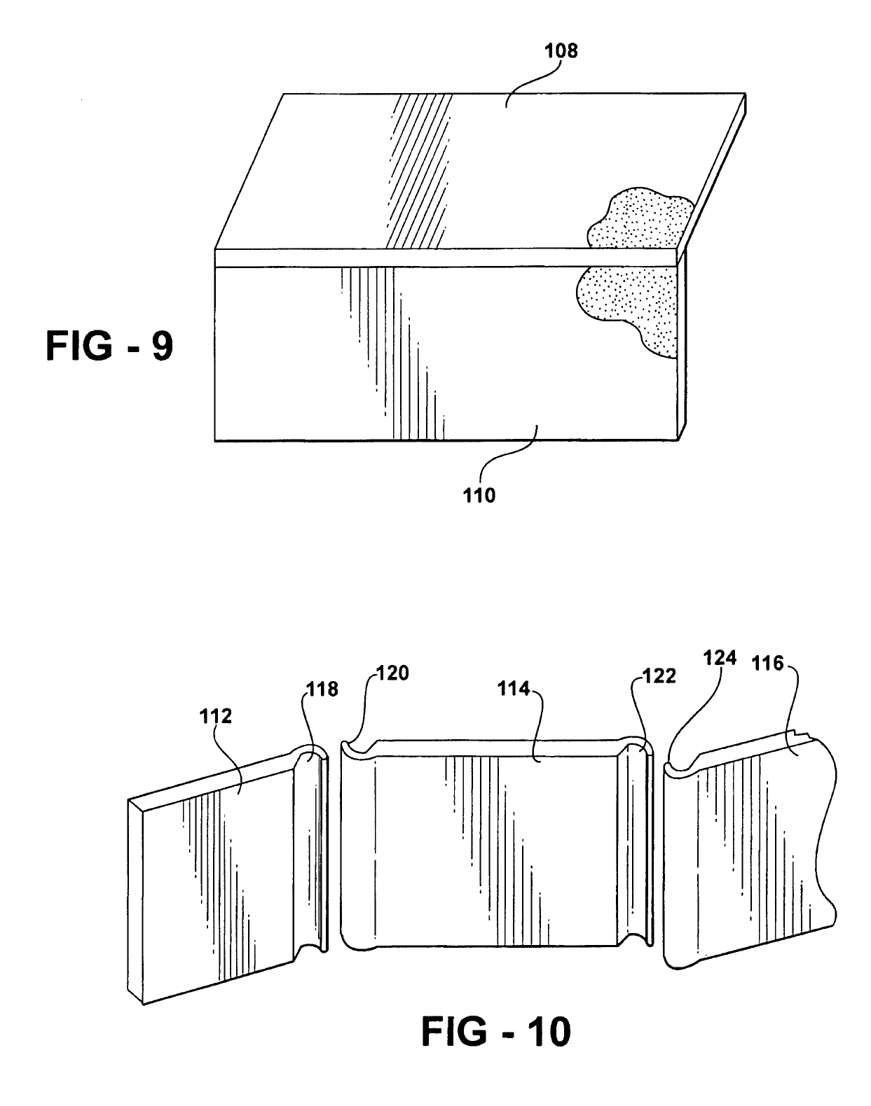

Referring now to FIGS. 9 and 10, it is also envisioned that appropriately configured and ceramic covered plates of material can be constructed, such as which may further be interlocked together, and in order to provide a blast resistant surface. Referring first to FIG. 9, a perspective illustration of appropriately configured and ceramic covered plates of material is shown at 108 and 110, and by which the plates are arranged in a desired fashion to provide a blast resistant surface.

Each of the plates 108 and 110 is constructed in a fashion similar to that disclosed in any of the preceding several embodiments, and which includes an outer ceramic layer(s), in cooperation with a desired admixture of lofted glass, resin, and fibrous sheet materials, with the further optional addition of an innermost steel/titanium deflection retardant mesh.

FIG. 10 is a further perspective illustration of a plurality of ceramic covered and multiple layer fiber reinforced materials, and such as which may further be configured as individual components 112, 114, 116, et seq., so as to be interlocked together, and in order to provide a blast resistant surface. In particular, each of the assembleable components may include a suitable lip and channel arrangement, see as illustrated in alternating fashion by channel 118 extending along an edge of component 112, opposite lip 120 and channel 122 edges associated with component 114, engaging lip 124 of component 116, et seq.

As stated previously, the shaping of the individual components is not limited to any configuration, it being understood that any suitable shape can be established by each of the aligning and engaging components, and through the application of forming processes associated with the present invention. Such includes arcuate and curved shapes for creating outer surface protection of arcuate surface areas associated with ship hulls, tanks, etc., and in addition to substantially planar and interengaging sheets for deck and floor armor protection.

A method for creating a multiple layer reinforced material, corresponding to the above-referenced assembly, includes the steps of applying a first layer of a lofted glass material, applying a second layer of a fiber reinforced material over the glass material, applying a further layer of lofted glass material over the fiber reinforced material. Additional steps include depositing a volume of a resin syrup upon the layers of glass material and the fiber reinforced material, applying a combination of heat and pressure to the layers of materials, and providing at least one of curing, trimming, sanding and planning operations, in succeeding order, to create a finished product.

Additional steps include applying multiple individual plies of material associated with at least one of the lofted glass and said fiber reinforced materials, applying a plurality of alternating layers of lofted glass and fiber reinforced material, applying the multiple individual plies of material in crosswise extending fashion, and applying a water impervious material to at least one surface associated with the material.

Yet additional steps include applying heat and pressure to compress the layered material from a first overall thickness to a second reduced thickness, depositing a sub-volume of resin syrup between each succeeding layer of lofted glass and fiber reinforced materials, and applying a resin material selected from the group including a polyurethane, epoxy, polyester, bi-phenol polyester, phenol formaldehyde, isothallic polyester, orthothallic polyester and a vinyl ester.

Other steps include applying the resin in a range of fifteen to eighty-five percent by weight in comparison to the layers of lofted glass and fiber reinforced material, and varying a chemical composition of the resin syrup to exhibit elongation properties similar to those associated with at least the fiber reinforced material. Additional steps include the step of fastening first and second sheets of material, each exhibiting an extending and overlapping edge associated with a lap joint, the step of forming aligning recesses in the overlapping edges associated with the first and second sheets of material, and further comprising the step of inserting a two-piece and assembleable pin within the aligning recesses. Finally, the step of forming each of the assembleable pin pieces from a reinforced chopped glass fiber is taught, each exhibiting a frusto-conical shape corresponding to frusto-conical shaped recesses defined in the overlapping lap joint edges. Having described my invention, additional preferred embodiments will become apparent to those skilled in the art to which it pertains and without deviating from the scope of the appended claims.

I claim:

1. A multiple layer fiber reinforced material, comprising:
at least a first layer of a lofted glass material;
at least a second layer of fiber reinforced material applied over said glass material;
at least a third layer of a lofted glass material applied over said fiber reinforced material; and
a resin intermixed with said layers of glass material and said fiber reinforced material, said resin exhibiting elongation properties substantially consistent with at least those associated with said layer of fiber reinforced material.

2. The reinforced material as described in claim 1, each of said layers of lofted glass material and fiber reinforced material further comprising multiple individual plies of material.

3. The reinforced material as described in claim 1, said fiber reinforced material further comprising a carbon Kevlar fiber.

4. The reinforced material as described in claim 1, further comprising a combined heat and compression process applied to said multiple layers of material and in order to form said reinforced material.

5. The reinforced material as described in claim 2, further comprising said multiple individual plies of fiber reinforced material being arranged in crosswise extending fashion.

6. The reinforced material as described in claim 1, wherein said resin penetrates completely through said first, second and third layers.

7. The reinforced material as described in claim 1, said resin further comprising at least one of a polyurethane, epoxy, polyester, bi-phenol polyester, phenol formaldehyde, isothallic polyester, orthothallic polyester and a vinyl ester.

8. The reinforced material as described in claim 1, further comprising said material having a specified shape and size and exhibiting an elongation rate of between six to twenty-five percent corresponding to an overall volume of said material.

9. The reinforced material as described in claim 1, said material exhibiting a specified shape and size, further comprising a surface coating of a water impervious material applied to at least one surface associated with said material.

10. The reinforced material as described in claim 4, further comprising said resin being applied in a flowable form upon said layers of material.

11. The reinforced material as described in claim 10, further comprising said resin being applied in a range of fifteen to eighty-five percent by weight in comparison to said layers of material.

12. The reinforced material as described in claim 1, said material exhibiting a specified shape and size and exhibiting a density of 55 to 72 pounds per cubic foot.

13. The reinforced material as described in claim 1, said material exhibiting a specified shape and size and exhibiting an impact load resistance ranging from 6700 psi to 8000 psi.

14. The reinforced material as described in claim 1, said material exhibiting a specified shape and size and having a tensile strength rating in a range of between 155-225 kips per square inch.

15. The reinforced material as described in claim 1, further comprising first and second sheets of material, each exhibiting an extending and overlapping edge associated with a lap joint, at least one fastener securing together said first and second sheets.

16. The reinforced material as described in claim 15, said fastener further comprising a two-piece and assembleable pin, aligning recesses being formed in said overlapping and extending edges for receiving, in inserting fashion, said pin pieces.

17. The reinforced material as described in claim 16, each of said assembleable pin pieces further comprising a frusto-conical shape corresponding to frusto-conical shaped recesses defined in said overlapping lap joint edges.

18. The reinforced material as described in claim 1, further comprising at least one layer of a ceramic based material.

19. The reinforced material as described in claim 18, said ceramic based material having a specified shape and size and defining an outermost layer of said multiple layer material.

20. The reinforced material as described in claim 1, further comprising a layer of a deformation retardant mesh.

21. The reinforced material as described in claim 20, said retardant mesh comprising at least one of a steel and a titanium material and defining an innermost layer of said multiple layer material.

22. A multiple layer fiber reinforced material, comprising:
a layer of a deformation retardant mesh material;
at least a first layer of a lofted glass material applied over said retardant mesh;
at least a second layer of metal mesh material applied over said glass material;
at least a third layer of a lofted glass material applied over said fiber reinforced material;
a resin intermixed with said layers of glass material and said metal mesh material, said resin exhibiting elongation properties substantially consistent with at least those associated with said layer of mesh material; and
a ceramic outer sacrificial layer applied over said resin.

23. The multiple layer fiber reinforced material as described in claim 22, further comprising a plurality of multi-layered articles engageable in end-to-end fashion to define an outer protective covering.

24. A method for creating a multiple layer reinforced material comprising the steps of:
applying a first layer of a lofted glass material;
applying a second layer of a fiber reinforced material over said glass material;
applying a further layer of lofted glass material over said fiber reinforced material;
depositing a volume of a resin syrup upon said layers of glass material and said fiber reinforced material;
applying a combination of heat and pressure to said layers of materials; and
providing at least one of curing, trimming, sanding and planning operations, in succeeding order, and to create a finished product.

25. The method as described in claim 24, further comprising the step of preapplying a deformation retardant mesh material prior to said lofted glass material.

26. The method as described in claim 24, further comprising the step of applying an outer ceramic based layer over said resin syrup.

27. The method as described in claim 24, further comprising the step of applying multiple individual plies of material associated with at least one of said lofted glass and said fiber reinforced materials.

28. The method as described in claim 24, further comprising the step of applying a plurality of alternating layers of lofted glass and fiber reinforced material.

29. The method as described in claim 27, further comprising the step of applying said multiple individual plies of material in crosswise extending fashion.

30. The method as described in claim 24, further comprising the step of applying a water impervious material to at least one surface associated with said material.

31. The method as described in claim 24, said step of applying heat and pressure further comprising the step of compressing said layered material from a first overall thickness to a second reduced thickness.

32. The method as described in claim 28, further comprising the step of depositing a sub-volume of resin syrup between each succeeding layer of lofted glass and fiber reinforced materials.

33. The method as described in claim 24, further comprising the step of applying a resin material selected from the group including a polyurethane, epoxy, polyester, bi-phenol polyester, phenol formaldehyde, isothallic polyester, orthothallic polyester and a vinyl ester.

34. The method as described in claim 24, further comprising the step of applying said resin in a range of fifteen to eighty-five percent by weight in comparison to said layers of lofted glass and fiber reinforced material.

35. The method as described in claim 24, further comprising the step of varying a chemical composition of said resin syrup to exhibit elongation properties similar to those associated with at least said fiber reinforced material.

36. The method as described in claim 24, further comprising the step of fastening first and second sheets of material, each exhibiting an extending and overlapping edge associated with a lap joint.

37. The method as described in claim 36, further comprising the step of forming aligning recesses in said overlapping edges associated with said first and second sheets of material, further comprising the step of inserting a two-piece and assembleable pin within said aligning recesses.

38. The reinforced material as described in claim 37, further comprising the step of forming each of said assembleable pin pieces from a reinforced chopped glass fiber exhibiting a frusto-conical shape corresponding to frusto-conical shaped recesses defined in said overlapping lap joint edges.
